(19) United States
(12) Patent Application Publication
(10) Pub. No.: US 2024/0231209 A1
(43) Pub. Date: Jul. 11, 2024

(54) ILLUMINATION MODULE AND OPTICAL APPARATUS THEREOF

(71) Applicants: Sintai Optical (Shenzhen) Co., Ltd., ShenZhen City (CN); Asia Optical Co., Inc., Taichung (TW)

(72) Inventors: Ru-Ping Huang, Taichung (TW); Chih-Peng Wang, Taichung (TW); Yung-Nen Xiao, Taichung (TW); Hsuan-Yu Lo, Taichung (TW); Chien-Chih Hsiung, Taichung (TW)

(21) Appl. No.: 18/544,648

(22) Filed: Dec. 19, 2023

(30) Foreign Application Priority Data
Jan. 6, 2023 (TW) 112100585

(51) Int. Cl. G03B 21/20; G02B 27/01

(52) U.S. Cl. CPC G03B 21/2033; G02B 27/0101; G02B 27/0149; G02B 2027/015

(57) ABSTRACT

An illumination module includes a light source and a first optical element. The illumination module is set in an optical apparatus. The light source includes a plurality of lighting units and each lighting unit emits a light beam, wherein the light beam includes a colored light and the light source emits a plurality of light beams. The first optical element includes a plurality of optical units.

### BACKGROUND OF THE INVENTION

### Field of the Invention

The invention relates to an illumination module and optical apparatus thereof.

### Description of the Related Art

Today's projector, virtual reality device, and augmented reality device all include optomechanical module. The optomechanical module includes imaging module and illumination module. Traditional imaging module and illumination module each account for about half the size of the optomechanical module. Traditional illumination module usually includes LED light sources, light-collecting collimating lens, three-color light combining lens, homogenizing fly-eye lens, and relay lens. In order to achieve good optical effect, more glass lenses are often used, resulting in the traditional illumination module being larger in size and heavier in weight. However, with the increasing application for virtual reality device and augmented reality device, the demand for slimmer virtual reality device and augmented reality device is also increasing. Among them, the slimming for the illumination module in the optomechanical module will play an important role. Therefore, the illumination module needs a new structure in order to meet the slimming requirement for the virtual reality device and augmented reality device.

### BRIEF SUMMARY OF THE INVENTION

The invention provides an illumination module to solve the above problems. The illumination module of the invention is provided with characteristics of a decreased volume, a decreased weight, increased light source usage efficiency, and can effectively reduce the volume of virtual reality device and augmented reality device.

The illumination module in accordance with an exemplary embodiment of the invention includes a light source and a first optical element. The illumination module is set in an optical apparatus. The light source includes a plurality of lighting units and each lighting unit emits a light beam, wherein the light beam includes a colored light and the light source emits a plurality of light beams. The first optical element includes a plurality of optical units. The illumination module satisfies at least one of the following conditions: 2≤VOU/VLU≤550; 0.3≤V1OE/VLS≤2.2; 8≤AOU/ALU≤16; 0.6≤(TLS+T1OE)/DLS1OE≤8.9; 0.2%≤V1OE/VIM≤50%; AOU>ALU×2; the number of the optical units of the first optical element is less than the number of the lighting units; wherein VOU is a volume of the optical unit of the first optical element, VLU is a volume of the lighting unit, V1OE is a volume of the first optical element, VLS is a volume of the light source, AOU is an area of the optical unit of the first optical element, ALU is an area of the lighting unit, TLS is a thickness of the light source, TOE is a thickness of the first optical element, DLS1OE is a shortest interval from the light source to the first optical element, and VIM is a volume of the illumination module.

The illumination module in accordance with another exemplary embodiment of the invention includes a light source and a first optical element. The illumination module is set in an optical apparatus. The light source includes a plurality of lighting units and each lighting unit emits a light beam, wherein the light beam includes a colored light and the light source emits a plurality of light beams. The first optical element includes a plurality of optical units. Each optical unit includes a curved surface facing the light source, wherein the curved surface has only one apex. The first optical element is disposed on one side of the light source. The light beams emitted by at least two lighting units are incident and passes through the same optical unit for light mixing.

The optical apparatus in accordance with an exemplary embodiment of the invention includes an illumination module, a second optical element, a first projection lens assembly, and an image source. The illumination module includes a light source and a first optical element. The light source includes a plurality of lighting units and each lighting unit emits a light beam, wherein the light beam includes a colored light and the light source emits a plurality of light beams. The first optical element includes a plurality of optical units. The first optical element is disposed on one side of the light source. The light beams emitted by at least two lighting units are incident and passes through the same optical unit for light mixing, then exits the illumination module, and then enters the second optical element. The second optical element includes a reflective surface and the reflective surface can partially reflect and partially transmit, or fully reflect the incident light beams. The optical apparatus satisfies at least one of the following conditions: 1.25 mm≤A2OES1/DLS2OES1≤50 mm; 2 mm≤DLS2OES1≤20 mm; 0.5%≤VIM/VOA≤19%; 2≤(DLU2OES2+DISPL1)/TIM≤17; wherein A2OES1 is an area of a first surface of the second optical element, DLS2OES1 is an interval from the light source to the first surface of the second optical element, VIM is a volume of the illumination module, VOA is a volume of the optical apparatus, DLU2OES2 is an interval from the light source to a second surface of the second optical element, DISPL1 is an interval from an image source to a light exiting surface of the first projection lens assembly, and TIM is a minimum interval from a first side surface of the light source to a second side surface of an optical element wherein the optical element is closest to the second optical element.

In another exemplary embodiment, the illumination module further includes a third optical element and the third optical element includes a plurality of optical units or a lens, wherein the first optical element is disposed between the light source and the third optical element, or the third optical element is disposed between the first optical element and the light source when the third optical element includes a plurality of optical units, and the first optical element is disposed between the light source and the third optical element when the third optical element is the lens.

In yet another exemplary embodiment, the illumination module further includes a fourth optical element and a fifth optical element, wherein the third optical element and the fourth optical element are disposed between the first optical element and the fifth optical element, and the light beams pass through the first optical element, the third optical element, the fourth optical element, and the fifth optical element in order.

In another exemplary embodiment, any optical unit of the first optical element includes two surfaces with lens structure, wherein one surface with lens structure faces the light source and the other surface with lens structure faces away from the light source, the surfaces with lens structure each has a radius of curvature, and the radiuses of curvature may be the same or different.

In yet another exemplary embodiment, any optical unit includes two surfaces with lens structure when the third optical element includes a plurality of optical unit, wherein one surface with lens structure faces the light source and the other surface with lens structure faces away from the light source, wherein the surfaces with lens structure each has a radius of curvature and the radiuses of curvature may be the same or different.

In another exemplary embodiment, the second optical element is disposed between the image source and the first projection lens assembly, the light beams incident on the second optical element are reflected by the reflective surface and enters the image source, then reflected by the image source to become an image light beam, then the image light beam passes through the second optical element, and then enters the first projection lens assembly, and the first projection lens assembly projects the image light beam to a screen to form an image.

In yet another exemplary embodiment, the optical apparatus further includes a sixth optical element, a seventh optical element, a second projection lens assembly, and another image source, wherein the sixth optical element is disposed between the second optical element and the seventh optical element, the seventh optical element is disposed between the another image source and the second projection lens assembly, and the seventh optical element includes a reflective surface, the light beams incident on the second optical element partially transmits the reflective surface of the second optical element, then enters and passes through the sixth optical element, then enters the seventh optical element, then part of the transmitted light beams will be reflected by the reflective surface of the seventh optical element and enters to the another image source, then reflected by the another image source to become another image light beam, then enters and passes through the seventh optical element, and then enters the second projection lens assembly, and the second projection lens assembly projects the another image light beam to the screen to form another image.

In another exemplary embodiment, the light source is a LED array light source and the LED array light source includes the lighting units of three colors, wherein the plurality of lighting units are arranged in a grid, the first optical element, the third optical element, the fourth optical element, the fifth optical element, and the sixth optical element all are made of plastic material, and an interval between the second optical element and the seventh optical element along the incident direction of the light beams can be adjusted, so that an interval between two images projected by the first projection lens assembly and the second projection lens assembly can be changed.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a schematic diagram of a first to sixth embodiments of an illumination module combined with optical element in accordance with the present invention;

FIG. 2 is a partially enlarged schematic diagram of the first embodiment of the illumination module in accordance with the present invention;

FIG. 3 is a schematic diagram of a first embodiment of an optical apparatus in accordance with the present invention;

FIG. 4 is a schematic diagram of a second embodiment of the optical apparatus in accordance with the present invention; and

FIG. 5 is a schematic diagram of a fifth embodiment of the optical apparatus in accordance with the present invention.

### DETAILED DESCRIPTION OF THE INVENTION

The following description is made for the purpose of illustrating the general principles of the invention and should not be taken in a limiting sense. The scope of the invention is best determined by reference to the appended claims.

The present invention provides an illumination module including a light source and a first optical element. The illumination module is set in an optical apparatus. The light source includes a plurality of lighting units and each lighting unit emits a light beam, wherein the light beam includes a colored light and the light source emits a plurality of light beams. The first optical element includes a plurality of optical units. The first optical element is disposed on one side of the light source. The light beams emitted by at least two lighting units are incident and passes through the same optical unit for light mixing.

The present invention provides another illumination module including a light source and a first optical element. The illumination module is set in an optical apparatus. The light source includes a plurality of lighting units and each lighting unit emits a light beam, wherein the light beam includes a colored light and the light source emits a plurality of light beams. The first optical element includes a plurality of optical units, each optical unit includes a curved surface facing the light source and the curved surface has only one apex. The first optical element is disposed on one side of the light source. The light beams emitted by at least two lighting units are incident and passes through the same optical unit for light mixing.

The present invention provides an optical apparatus including the above illumination module. The optical apparatus includes an illumination module including a light source and a first optical element, wherein the illumination module can be the illumination module of any of the above-mentioned embodiment; a second optical element; a first projection lens assembly; and an image source. The light source includes a plurality of lighting units and each lighting unit emits a light beam, wherein the light beam includes a colored light and the light source emits a plurality of light beams. The first optical element includes a plurality of optical units. The first optical element is disposed on one side of the light source. The light beams emitted by at least two lighting units are incident and passes through the same optical unit for light mixing, then exits the illumination module, and then enters the second optical element. The second optical element can be, but not limited to, a prism, and can also be other optical element including a reflective surface. The reflective surface of the second optical element has an optical thin film that can partially reflect partially pass through, or fully reflect the incident light beams. For example, the mixed light beams can be reflected by the second optical element and directed to the first direction and exit the second optical element when the mixed light is a S polarized light and the second optical element is totally reflective for the S polarized light and the P polarized light can pass through; the S polarized light can be reflected by the second optical element and directed to a first direction and exit the second optical element, and the P polarized light can pass through the second optical element and directed to a second direction and exit the second optical element when the mixed light has a S polarized light and a P polarized light, and the second optical element is totally reflective for the S polarized light and passable for the P polarized light. The above illumination module can reduce the volume and provide the effect of light mixing and uniformity.

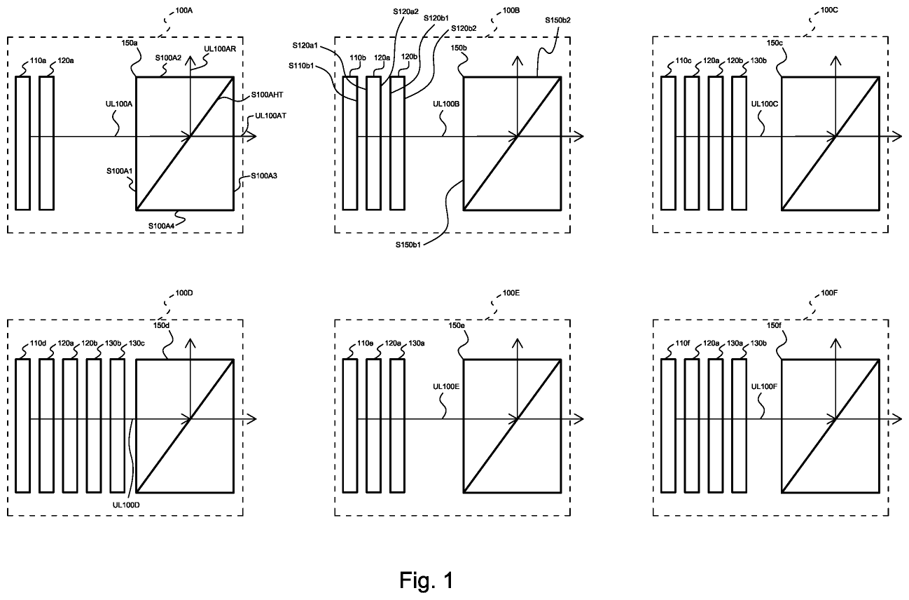

The above embodiment can achieve basic requirement and function, and the following are other embodiments of the present invention. Referring to FIG. 1, FIG. 1 is illumination modules combined with optical element of other embodiments of the present invention. The effect of light mixing is the same as that of the above embodiment, and is not described here again. For the convenience of explaining the light path below, the colored lights emitted by the plurality of lighting units of the light source and the light before enters the second optical element is referred to as light beam, and for the convenience of explaining the relationship between the light beam generated by the illumination module and the optical apparatus, a second optical element of the optical apparatus will appear in order to describe the following illumination module. In the first embodiment, an illumination module combined with optical element 100A includes a light source 110a, a first optical element 120a, and a second optical element 150a. The first optical element 120a is disposed between the light source 110a and the second optical element 150a. The second optical element 150a includes a first surface S100A1, a second surface S100A2, a third surface S100A3, a fourth surface S100A4, and a reflective surface S100AHT. The reflective surface S100AHT includes an optical thin film (not shown) which can totally reflect the incident light beam or split it into two light beams. The light source 110a emits a light beam UL100A, the light beam UL100A enters and passes through the first optical element 120a, and then enters the second optical element 150a from the first surface S100A1. The light beam UL100A can form a first reflected light beam UL100AR and/or a first transmitted light beam UL100AT when the light beam UL100A1 enters the optical thin film (not shown). The first transmitted light beam UL100AT exits the second optical element 150a from the third surface S100A3 (the second direction). The first reflected light beam UL100AR directed to a direction (the first direction) intersecting with the incident direction of the light beam UL100A and exits the second optical element 150a from the second surface S100A2, wherein the intersected direction can be a vertical direction. The main function of the first optical element 120a is to collimate, mix, uniform and narrow the angle for the incident light beam UL100A to obtain the light beam UL100A with good light mixing property and uniformity of the light intensity. The above light source 110a can be an LED array light source; the first optical element 120a can be a first micro lens array; the second optical element 150a can be a first polarization beam splitter; wherein the first transmitted light beam UL100AT is generated when the light beam UL100A contains two polarization states and the reflective surface of the second optical element 150a can split the incident light beam into two light beams.

Referring to FIG. 1, in the second embodiment, an illumination module combined with optical element 100B includes a light source 110b, a first optical element 120a, a third optical element 120b, and a second optical element 150b. The first optical element 120a is disposed between the light source 110b and the third optical element 120b. The third optical element 120b is disposed between the first optical element 120a and the second optical element 150b. The structure and function of the second optical element 150b are the same as that of the second optical element 150a of the first embodiment. The light source 110b emits a light beam UL100B, the light beam UL100B enters and passes through the first optical element 120a, then enters and exits the third optical element 120b, and finally enters the second optical element 150b. The optical path of the light beam UL100B after enters the second optical element 150b is the same as that of the illumination module of the first embodiment, and is not described here again. In addition, the design of the first optical element 120a and the third optical element 120b in this embodiment helps to shorten the total optical path and more effectively collimate, mix, and uniform the light beam. The above light source 110b can be an LED array light source; the first optical element 120a can be a first micro lens array; the third optical element 120b can be a second micro lens array; the second optical element 150b can be a first polarization beam splitter.

Referring to FIG. 1, in the third embodiment, an illumination module combined with optical element 100C includes a light source 110c, a first optical element 120a, a third optical element 120b, a fourth optical element 130b, and a second optical element 150c. The structure and function of the second optical element 150c are the same as that of the second optical element 150a of the first embodiment. The light source 110c emits a light beam UL100C, the light beam UL100C enters and passes through the first optical element 120a, then enters and passes through the third optical element 120b, then enters and passes through the fourth optical element 130b, and finally enters the second optical element 150c. The optical path of the light beam UL100C after enters the second optical element 150b is the same as that of the illumination module of the first embodiment, and is not described here again. The above light source 110c can be an LED array light source; the first optical element 120a can be a first micro lens array; the third optical element 120b can be a second micro lens array; the fourth optical element 130b can be a second relay lens; the second optical element 150c can be a first polarization beam splitter.

Referring to FIG. 1, in the fourth embodiment, an illumination module combined with optical element 100D includes a light source 110d, a first optical element 120a, a third optical element 120b, a fourth optical element 130b, a fifth optical element 130c, and a second optical element 150d. The structure and function of the second optical element 150d are the same as that of the second optical element 150a of the first embodiment. The light source 110d emits a light beam UL100D, the light beam UL100D enters and passes through the first optical element 120a, then enters and passes through the third optical element 120b, then enters and passes through the fourth optical element 130b, then enters and passes through the fifth optical element 130c, and finally enters the second optical element 150d. The optical path of the light beam UL100D after enters the second optical element 150d is the same as that of the illumination module of the first embodiment, and is not described here again. The above light source 110d can be an LED array light source; the first optical element 120a can be a first micro lens array; the third optical element 120b can be a second micro lens array; the fourth optical element 130b can be a second relay lens; the fifth optical element 130c can be a third relay lens; the second optical element 150d can be a first polarization beam splitter.

Referring to FIG. 1, in the fifth embodiment, an illumination module combined with optical element 100E includes a light source 110e, a first optical element 120a, a third optical element 130a, and a second optical element 150e. The structure and function of the second optical element 150e are the same as that of the second optical element 150a of the first embodiment. The light source 110e emits a light beam UL100E, the light beam UL100E enters and passes through the first optical element 120a, then enters and passes through the third optical element 130a, and finally enters the second optical element 150e. The optical path of the light beam UL100E after enters the second optical element 150e is the same as that of the illumination module of the first embodiment, and is not described here again. The above light source 110c can be an LED array light source; the first optical element 120a can be a first micro lens array; the third optical element 130a can be a first relay lens; the second optical element 150e can be a first polarization beam splitter.

Referring to FIG. 1, in the sixth embodiment, an illumination module combined with optical element 100F include a light source 110f, a first optical element 120a, a third optical element 130a, a fourth optical element 130b, and a second optical element 150f. The structure and function of the second optical element 150f are the same as that of the second optical element 150a of the first embodiment. The light source 110f emits a light beam UL100F, the light beam UL100F enters and passes through the first optical element 120a, then enters and passes through the third optical element 130a, then enters and passes through the fourth optical element 130b, and finally enters the second optical element 150f. The optical path of the light beam UL100F after enters the second optical element 150f is the same as that of the illumination module of the first embodiment, and is not described here again. The above light source 110f can be an LED array light source; the first optical element 120a can be a first micro lens array; the third optical element 130a can be a first relay lens or a film which is controllable for horizontal/vertical viewing angle; the fourth optical element 130b can be a second relay lens or a film which is controllable for horizontal/vertical viewing angle; the second optical element 150f can be a first polarization beam splitter.

The surface shape of the above first relay lens, the second relay lens, and the third relay lens can be a biconvex, a meniscus, a plano-convex, a convex-plano, a plano-concave, or a concave-plano, and with positive or negative refractive power among which the lens with positive refractive power is preferred which helps to adjust the spot size and the illumination magnification. The above first micro lens array, the second micro lens array, the first relay lens, the second relay lens, and the third relay lens all can be made of plastic material which is more conducive for thinning and lightening. The above illumination module combined with optical element 100A-100F can be applied to the light source for the optomechanical module, and the optomechanical module can be applied to image generation system such as projector, head-up display, and head-mounted display. The above first relay lens, second relay lens, and third relay lens can be an aspherical lens, a Fresnel lens, or a micro lens of optical film, and its function is to evenly enlarge the spot size of the illumination. In other embodiments, based on any of the above embodiment and meets at least one of the following conditions, it is possible to further effectively achieve thinning, lightening, and uniform lighting:

2 mm≤DLS2OES1≤20 mm;

6.25 mm²≤A2OES1≤100 mm²;

1.49≤the refractive index of the first optical element (Nd)≤1.59;

0.1 mm≤DLS1OE≤1 mm;

0 mm≤the radius of curvature on either side of the first optical element≤2.5 mm;

2≤VOU/VLU≤550;

0.3≤V1OE/VLS≤2.2;

8≤AOU/ALU≤16;

0.6≤(TLS+T1OE)/DLS1OE≤8.9;

0.2%≤V1OE/VIM≤50%;

AOU>ALU×2;

1.25 mm≤A2OES1/DLS2OES1≤50 mm;

0.5%≤VIM/VOA≤19%;

2≤(DLU2OES2+DISPL1)/TIM≤17;
the number of the optical unit of the first optical element is less than the number of the lighting unit;
wherein VOU is a volume of the optical unit of the first optical element, VLU is a volume of the lighting unit, V1OE is a volume of the first optical element, VLS is a volume of the light source, AOU is an area of the optical unit of the first optical element, ALU is an area of the lighting unit, TLS is a thickness of the light source, T1OE is a thickness of the first optical element, DLS1OE is a shortest interval from the light source to the first optical element, VIM is a volume of the illumination module, A2OES1 is an area of a first surface of the second optical element, DLS2OES1 is an interval from the light source to the first surface of the second optical element, VOA is a volume of the optical apparatus, DLU2OES2 is an interval from the light source to a second surface of the second optical element, DISPL1 is an interval from an image source to a light exiting surface of the first projection lens assembly, and TIM is a minimum interval from a first side surface of the light source (the side opposite to the light exiting surface, that is, the side faces away from the light) to a second side surface of the optical element closest to the second optical element.

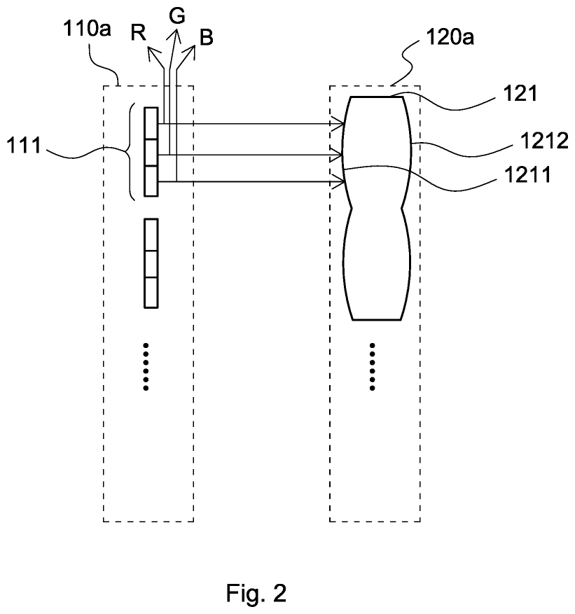

Referring to FIG. 2, FIG. 2 is a partially enlarged schematic diagram of the light source 110a and the first optical element 120a in FIG. 1. The light source 110a is a LED array including a plurality of lighting components 111, the lighting component 111 includes R, G, B lighting units, each R, G, B unit emits a colored light. The lighting units R, G, B can be red, blue, green or other different three-color LEDs. The LED array includes 45-160 pieces of lighting units. The lighting units R, G, and B are arranged in a grid pattern, for example, 5 in each row and 9 in each column, and the interval between the lighting units can be equal according to the requirements, that is, the interval between the lighting components 111 is equal to that of the lighting units. The first optical element 120a is a first micro lens array which includes optical unit 121, wherein the number of the optical unit 121 corresponding to the number of lighting component 111. The outer circumference of the optical unit 121 includes at least two lighting units R, G, B within the projection range of the light source 110a. Each optical unit 121 is set on one side of the lighting component 111. The lighting unit R emits red light, the lighting unit G emits green light, and the lighting unit B emits blue light, all of which enter the optical unit 121, wherein the optical unit 121 can mix the incident red light, green light and blue light and reduce the divergence angle of the exit light beam, so that the red light, green light, and blue light pass through the optical unit 121 to form mixed light, and the half divergence angle of the mixed light is less than 30 degrees. The optical unit 121 can be designed with a double-sided or single-sided lens structure according to requirement and the optical unit 121 includes an incident surface 1211 and an exit surface 1212. The incident surface 1211 and the exit surface 1212 are both convex surfaces when the design is the double-sided lens structure. The incident surface 1211 is a plane surface and the exit surface 1212 is a convex surface when the design is the single-sided lens structure. The above convex surface is an arc surface or a conical surface with only one apex. The structure of the second micro lens array can be the same as that of the first micro lens array when the third optical element is a second micro lens array. In addition, the incident surface and the exit surface of the first micro lens array and the second micro lens array can have the same radius of curvature R or different radius of curvature R according to requirement. Each of the optical units includes an adjacent surface, the incident surface 1211 and the exit surface 1212 are connected through the adjacent surface, and each of the optical units connects the adjacent optical unit through the adjacent surface, so that the light beam can enter the optical units at the same time.

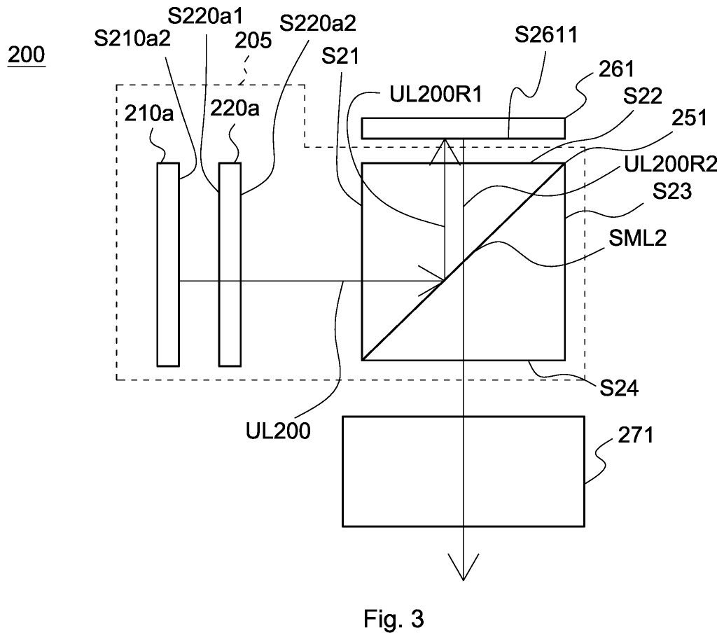

Referring to FIG. 3, FIG. 3 is a schematic diagram of a first embodiment of an optical apparatus in accordance with the present invention. The optical apparatus 200 includes an illumination module combined with optical element 205, an image source 261, and a first projection lens assembly 271. The illumination module combined with optical element 205 includes a light source 210a, a first optical element 220a, and a second optical element 251. The light source 210a emits a light beam UL200, the light beam UL200 passes through the first optical element 220a, so that the light beam UL200 emitted from the first optical element 220a has the characteristics of good light mixing and good uniformity for light intensity. The second optical element 251 includes a first surface S21, a second surface S22, a third surface S23, a fourth surface S24, and a reflective surface SML2, wherein the reflective surface SML2 includes an optical thin film (not shown). The light beam UL200 passes through the first optical element 220a, then enters the second optical element 251 from the first surface S21. The light beam UL200 will be reflected when the light beam UL200 enters the optical thin film (coated on the reflective surface SML2), so that a first reflected light beam UL200R1 directed to the first direction which intersecting with the incident direction of the light beam UL200, and finally exits the second optical element 251 from the second surface S22, then enters the image source 261, then the image source 261 reflects the first reflected light beam UL200R1 and adds image and changes the polarization state to form the second reflected light beam UL200R2, then the second reflected light beam UL200R2 with image enters the second optical element 251 from the second surface S22, then passes through the optical thin film and the reflective surface SML2, and finally exits the second optical element 251 from the fourth surface S24. The second reflected light beam UL200R2 emitted from the fourth surface S24 enters the first projection lens assembly 271, then the second reflected light beam UL200R2 projected from the first projection lens assembly 271 can present an image on an imaging element (not shown). The imaging element can be a screen, windshield, head-mounted display, etc. The above light source 210a can be an LED array light source; the first optical element 220a can be a first micro lens array; the second optical element 251 can be a first polarization beam splitter; the image source 261 can be a first reflective LCD panel.

Table 1 shows relevant parameters for the first embodiment of the optical apparatus. The first surface 220al and the second surface 220a2 of the first optical element 220a have different R value, which are helpful for adjusting spot size and collimation. In other embodiments, the illumination module combined with optical element of this embodiment can further include a third optical element, that is, the illumination module combined with optical element 205 of FIG. 3 is replaced with 100B of FIG. 1, so that, the first surface and the second surface of the first optical element can have the same radius of curvature, both of which are 1.8-2.5 mm, and the first surface and the second surface of the third optical element may have the same radius of curvature, both of which are 0.8-0.85 mm; or the radius of curvature of the first surface and the second surface of the first optical element may have the same radius of curvature, both of which are 0.8-0.85 mm, and the radius of curvature of the first surface and the second surface of the third optical element may have the same radius of curvature, both of which are 1.8-2.5 mm.

TABLE 1
Light Source Area: 56.25 or 64 mm²
Light Source Emitting Angle: 40-60 degrees
The Second Optical Element Volume: 1000 or 343 mm³

| | Radius of | | | Effective | |
|---|---|---|---|---|---|
| Surface | Curvature | Thickness | | Focal Length | |
| Number | (mm) | (mm) | Nd/Vd | (mm) | Remark |
| 210 | ∞ | 0.5-2 | | | 210a |
| | | 0.5 | | | |
| 220a1 | 1.8-2.5 | 1-2 | 1.535/56 | 1.5-1.7 | 220a |
| 220a2 | 0.8-0.85 | | | | |
| | | 1-5 | | | |
| S21 | ∞ | | 1.5168 | ∞ | 251 |
| S22 | ∞ | | | | |
| | | 0.5-1 | | | |
| 261 | ∞ | | | | 261 |

Table 4 shows the parameters and condition values in accordance with the first embodiment of the optical apparatus of the present invention.

TABLE 4

| | | | | | | | | |
|---|---|---|---|---|---|---|---|---|
| VOU | 0.09-1.55 | mm³ | VLU | 0.003-0.006 | mm³ | V1OE | 56.25-128 | mm³ |
| VLS | 28-128 | mm³ | AOU | 0.3-0.8 | mm² | ALU | 0.03-0.06 | mm² |
| TLS | 0.5-2 | mm | T1OE | 1-2 | mm | DLS1OE | 0.5 | mm |
| VIM | 112.5-288 | mm³ | A2OES1 | 56.25-64 | mm² | DLS2OES1 | 3-9.5 | mm |
| VOA | 780-4186 | mm³ | DLU2OES2 | 4-11.5 | mm | DISPL1 | 26 | mm |
| TIM | 2-4.5 | mm | | | | | | |

| | | | | | |
|---|---|---|---|---|---|
| VOU/VLU | 30.5-285.3 | V1OE/VLS | 1-2 | VIM/VOA | 8%-14.% |
| AOU/ALU | 9.4-14.3 | (TLS + T1OE)/ | 3-8 | V1OE/VIM | 3%-50% |
| | | DLS1OE | | | |
| A2OES1/ | 6.7-18.8 | (DLU2OES2 + | 8-15 | | |
| DLS2OES1 | | DISPL1)/TIM | | | |

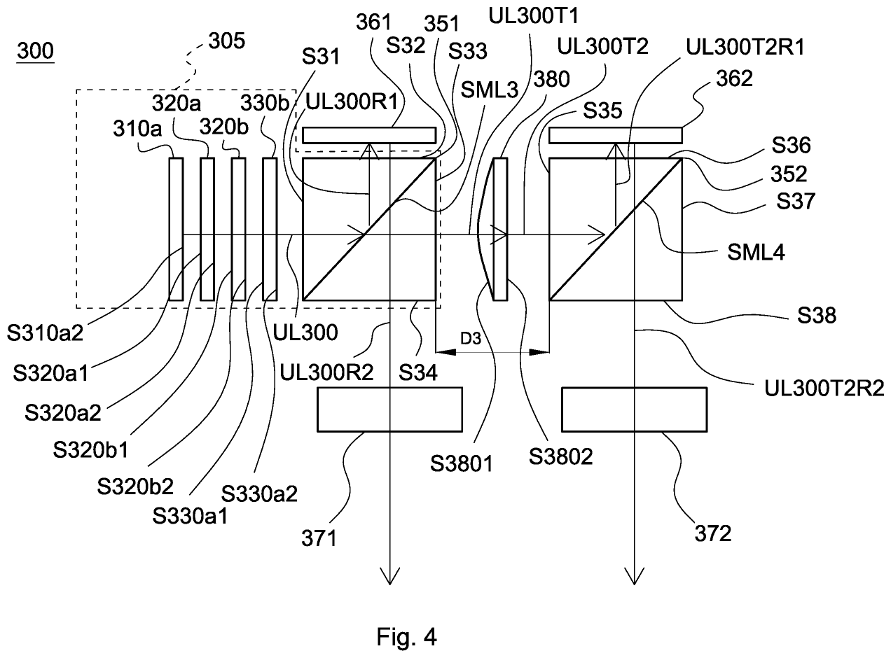

Referring to FIG. 4, FIG. 4 is a schematic diagram of a second embodiment of an optical apparatus in accordance with the present invention. The optical apparatus 300 includes an illumination module combined with optical element 305, an image source 361, a first projection lens assembly 371, a sixth optical element 380, a seventh optical element 352, an image source 362, and a second projection lens assembly 372. The illumination module combined with optical element 305 includes a light source 310a, a first optical element 320a, a third optical element 320b, a fourth optical element 330b, and a second optical element 351. The second optical element 351 includes a first surface S31, a second surface S32, a third surface S33, a fourth surface S34, and a reflective surface SML3. The seventh optical element 352 includes a first surface S35, a second surface S36, a third surface S37, a fourth surface S38, and a reflective surface SML4. The reflective surface SML3 and the reflective surface SML4 include an optical thin film (not shown), respectively. The optical thin film on the reflective surface SML3 allows the incident light beam to be divided into a transmitted light beam and a reflected light beam. The second optical element 351 is disposed between the image source 361 and the first projection lens assembly 371. The seventh optical element 352 is disposed between the image source 362 and the second projection lens assembly 372. The sixth optical element 380 is disposed between the second optical element 351 and the seventh optical element 352. The light source 310a emits a light beam UL300, the light beam UL300 passes through the first optical element 320a, the third optical element 320b, and the fourth optical element 330b in order, so that the light beam UL300 emitted from the fourth optical element 330b has the characteristics of good light mixing and good uniformity for light intensity. The light beam UL300 passes through the fourth optical element 330b and enters the second optical element 351 from the first surface S31. The light beam UL300 includes a S polarized light beam and a P polarized light beam, wherein the S polarized light beam will be reflected to form the first reflected light beam UL300R1 and the P polarized light beam will pass through the optical thin film and the reflective surface SML3 to form a first transmitted light beam UL300T1, when the light beam UL300 enters the optical thin film (coated on the reflective surface SML3), so that the first transmitted light beam (P polarization state) UL300T1 exits the second optical element 351 from the third surface S33 and the first reflected light beam (S polarization state) UL300R1 is reflected and directed to the first direction which intersecting with the incident direction of the light beam UL300, then exits the second optical element 351 from the second surface S32, then enters the image source 361, then the image source 361 reflects the first reflected light beam (S polarization state) UL300R1 and adds image and changes the polarization state to form an image light beam (the second reflected light beam, P polarization state) UL300R2, the image light beam (the second reflected light beam, P polarization state) UL300R2 enters the second optical element 351 from the second surface S32, then passes through the optical thin film (not shown, coated on the reflective surface SML3) and the reflective surface SML3, then exits the second optical element 351 from the fourth surface S34, then enters the first projection lens assembly 371, then the image light beam (the second reflected light beam, P polarization state) UL300R2 projected from the first projection lens assembly 371 can present an image on an screen (not shown). The above first transmitted light beam (P polarization state) UL300T1 exits the second optical element 351 from the third surface S33 and then enters and passes through the sixth optical element 380. The sixth optical element 380 includes a ½ wavelength plate and a lens, the ½ wavelength plate and the lens can be cemented together without an air gap, but in other embodiments, they are not cemented and are separated by an air gap, and the lens is a biconvex lens, a meniscus lens, or a plano-convex lens with positive refractive power, and the first transmitted light beam (P polarization state) UL300T1 passes through the lens first and then passes through the ½ wavelength plate, but it is not limited to this, in other embodiments, it can also pass through the ½ wavelength plate first and then pass through the lens. The first transmitted light beam (P polarization state) UL300T1 will change the polarization state to form a second transmitted light beam (S polarization state) UL300T2 when passes through the sixth optical element 380, the second transmitted light beam (S polarization state) UL300T2 enters the seventh optical element 352 from the first surface S35, then the second transmitted light beam (S polarization state) UL300T2 is reflected by the optical thin film (coated on the reflective surface SML4) to form the third reflected light beam (S polarization state) UL300T2R1, the third reflected light beam (S polarization state) UL300T2R1 directed to the first direction which intersecting with the incident direction of the light beam UL300, then exits the seventh optical element 352 from the second surface S36, then enters the image source 362, then the image source 362 reflects the third reflected light beam (S polarization state) UL300T2R1 and adds image and changes the polarization state to form an image light beam (the fourth reflected light beam, P polarization state) UL300T2R2, then the image light beam (the fourth reflected light beam, P polarization state) UL300T2R2 enters the seventh optical element 352 from the second surface S36, then passes through the optical thin film (not shown, coated on the reflective surface SML4) and the reflective surface SML4, and finally exits the seventh optical element 352 from the fourth surface S38, then enters the second projection lens assembly 372, then the image light beam (the fourth reflected light beam, P polarization state) UL300T2R2 projected by the second projection lens assembly 372 can present another image on the screen (not shown). The second embodiment of the optical apparatus of the present invention can achieve an image generation system for two eyes or dual screens that uses one set of illumination module, which not only makes the projector smaller in size and lighter in weight, and improve the light source usage efficiency of the illumination module. In addition, the interval D3 between the second optical element 351 and the seventh optical element 352 along the light beam incident direction can also be designed to be adjustable, so that the interval between the two images projected by the first projection lens assembly 371 and the second projection lens assembly 372 can be adjusted to meet the requirements of the user's eye width or projection space. In addition, one side of the first optical element 320a facing the light source 310a is a plane surface, and the other side is a curved surface to help collimate the light beam UL300. The above light source 310a can be an LED array light source; the first optical element 320a can be a first micro lens array; the second optical element 351 can be a first polarization beam splitter; the third optical element 320b can be a second micro lens array; the fourth optical element 330b can be a second relay lens; the seventh optical element 352 can be a second polarization beam splitter, the image source 361 can be a first reflective LCD panel; the image source 362 can be a second reflective LCD panel. Table 2 shows relevant parameters for the second embodiment of the optical apparatus. In other embodiments, the ½ wavelength plate can be disposed on the third surface S33 of the second optical element 351 or the first surface S35 of the seventh optical element 352 without an air gap, or independently disposed between the second optical element 351 and the seventh optical element 352.

TABLE 2
Light Source Area: 16 mm²
Light Source Emitting Angle: 40-60 degrees
The Second Optical Element Volume: 1000 mm³

| | Radius of | | | Effective | |
|---|---|---|---|---|---|
| Surface | Curvature | Thickness | | Focal Length | |
| Number | (mm) | (mm) | Nd/Vd | (mm) | Remark |
| 310a | ∞ | 0.5-2 | | | 310a |
| | | 1 | | | |
| 320a1 | ∞ | 2.55 | 1.535/56 | 1.7 | 320a |
| 320a2 | 0.05 | | | | |
| | | 0.2 | | | |
| 320b1 | 1.2 | 0.5 | 1.535/56 | 0.4 | 320b |
| 320b2 | 1.2 | | | | |
| | | 5 | | | |
| 330a1 | 11 | 2 | 1.883/40 | 11 | 330b |
| 330a2 | 11 | | | | |
| | | 0.5 | | | |
| S31 | ∞ | 10 | 1.5168/64 | ∞ | 351 |
| S33 | ∞ | | | | |
| | | 0.75 | | | |
| 380a1 | 16 | 1.5 | 1.516/64 | 25 | 380 |
| 380a2 | ∞ | | | | |
| | | 0.75 | | | |
| S35 | ∞ | 10 | 1.5168/64 | ∞ | 352 |
| S37 | ∞ | | | | |

Table 5 shows the parameters and condition values in accordance with the second embodiment of the optical apparatus of the present invention.

TABLE 5

| | | | | | | | | |
|---|---|---|---|---|---|---|---|---|
| VOU | 0.04-2.72 | mm³ | VLU | 0.003-0.006 | mm³ | V1OE | 8-40.8 | mm³ |
| VLS | 8-32 | mm³ | AOU | 0.3-0.8 | mm² | ALU | 0.03-0.06 | mm² |
| TLS | 0.5-2 | mm | T1OE | 0.5-2.55 | mm | DLS1OE | 1-3.75 | mm |
| VIM | 188-212 | mm³ | A2OES1 | 100 | mm² | DLS2OES1 | 3-13.75 | mm |
| VOA | 1040-8645 | mm³ | DLU2OES2 | 4-23.75 | mm | DISPL1 | 26 | mm |
| TIM | 11.75-13.25 | mm | | | | | | |

| | | | | | |
|---|---|---|---|---|---|
| VOU/VLU | 15.2-499.3 | V1OE/VLS | 1-1.3 | VIM/VOA | 2.4%-18.2% |
| AOU/ALU | 9.4-14.3 | (TLS + T1OE)/ | 1-1.3 | V1OE/VIM | 1.3%-19.3% |
| | | DLS1OE | | | |
| A2OES1/ | 7.2-33.4 | (DLU2OES2 + | 2.5-3.8 | | |
| DLS2OES1 | | DISPL1)/TIM | | | |

The following is the third embodiment of the optical apparatus of the present invention. The difference from the first embodiment is that the illumination module of this embodiment further includes a third optical element, that is, the illumination module combined with optical element 205 in FIG. 3 is replaced by 100B in FIG. 1, and the position of the third optical element and the first optical element are reversed, that is, the third optical element is disposed between the first optical element and the light source. In this embodiment, the number of the optical unit of the third optical element is greater than the number of the optical units of the first optical element, and the area of the third optical element facing the light source can be larger than the area of the first optical element facing the light source according to requirement, and the area of the outer circumference of the third optical element is less than or equal to the area of single lighting unit of the light source within the projection range of the light source, and the other similar components will not be described again. Table 3 is a table of relevant parameters of the components of the third embodiment of the optical device of the present invention.

TABLE 3
Light Source Area: 9 mm²
Light Source Emitting Angle: 120 degrees
The Second Optical Element Volume: 125 mm³

| | | | | Effective | |
|---|---|---|---|---|---|
| | Radius of | | | Focal | |
| Surface | Curvature | Thickness | | Length | |
| Number | (mm) | (mm) | Nd/Vd | (mm) | Remark |
| | ∞ | 0.5-2 | | | Light Source |
| | | 1 | | | |
| Facing | ∞ | 0.2 | 1.58/34 | 0.096 | The Third |
| Light | | | | | Optical |
| Source | | | | | Element |
| Facing | 0.05 | | | | |
| away | | | | | |
| Light | | | | | |
| Source | | | | | |
| | | 1.35 | | | |
| Facing | 0.6 | 0.9 | 1.535/56 | 0.4 | The First |
| Light | | | | | Optical |
| Source | | | | | Element |
| Facing | 0.6 | | | | |
| away | | | | | |
| Light | | | | | |
| Source | | | | | |
| | | 0.5 | | | |
| Facing | ∞ | 5 | 1.516/64 | ∞ | The Second |
| Light | | | | | Optical |
| Source | | | | | Element |
| Facing | ∞ | | | | |
| away | | | | | |
| Light | | | | | |
| Source | | | | | |
| | | 0.4 | | | |
| | ∞ | | | | Image Source |

Table 6 shows the parameters and condition values in accordance with the third embodiment of the optical apparatus of the present invention.

TABLE 6

| VOU | 0.009-1.162 | mm³ | VLU | 0.003-0.006 | mm³ | V1OE | 1.8-8.1 | mm³ |
|---|---|---|---|---|---|---|---|---|
| VLS | 4-18 | mm³ | AOU | 0.3-0.8 | mm² | ALU | 0.03-0.06 | mm² |
| TLS | 0.5-2 | mm | T1OE | 0.2-0.9 | | DLS1OE | 1-2.55 | mm |
| VIM | 35.5-49.5 | mm³ | A2OES1 | 25 | mm² | DLS2OES1 | 4.45-5.95 | mm |
| VOA | 1228.5-8645 | mm³ | DLU2OES2 | 9.45-23.75 | mm | DISPL1 | 26 | mm |
| TIM | 3.95-5.45 | mm | | | | | | |

| | | | | | |
|---|---|---|---|---|---|
| VOU/VLU | 3-214 | V1OE/VLS | 0.4-0.45 | VIM/VOA | 0.5%-2.9% |
| AOU/ALU | 9.4-14.3 | (TLS + T1OE)/ | 0.7-1.2 | V1OE/VIM | 0.3%-16.5% |
| | | DLS1OE | | | |
| A2OES1/ | 4.2-5.7 | (DLU2OES2 + | 8.97-9.2 | | |
| DLS2OES1 | | DISPL1)/TIM | | | |

The following is the fourth embodiment of the optical apparatus of the present invention. The difference from the first embodiment is that the illumination module of this embodiment further includes a third optical element and a fourth optical element, that is, the illumination module combined with optical element 205 in FIG. 3 is replaced by 100F in FIG. 1, and the third optical element is a film which is controllable for horizontal viewing angle and the fourth optical element is a film which is controllable for vertical viewing angle. In another embodiment, the third optical element is a film which is controllable for vertical viewing angle and the fourth optical element is a film which is controllable for horizontal viewing angle. The controllable viewing angle film is, for example, a film containing a grating structure or a privacy filter. The third optical element and the fourth optical element are disposed between the first optical element and the second optical element, and there may be an air gap between the third optical element and the fourth optical element, or there may be no air gap. In addition, there may also be an air gap between the fourth optical element and the second optical element, or there may be no air gap.

TABLE 7
Light Source Area: 9-25 mm²
Light Source Emitting Angle: 90-150 degrees
The Second Optical Element Volume: 27-125 mm³

| | | | | Effective | |
|---|---|---|---|---|---|
| | Radius of | | | Focal | |
| Surface | Curvature | Thickness | | Length | |
| Number | (mm) | (mm) | Nd/Vd | (mm) | Remark |
| | ∞ | 0.1 | | | Light Source |
| | | 0.5-1 | | | |
| Facing | ∞ | 0.2 | 1.58/34 | 0.096 | The First |
| Light | | | | | Optical |
| Source | | | | | Element |
| Facing | 0.05 | | | | |
| away | | | | | |
| Light | | | | | |
| Source | | | | | |
| | | 0.1-0.4 | | | |
| Facing | ∞ | 0.1 | 1.535/56 | ∞ | The Third |
| Light | | | | | Optical |
| Source | | | | | Element |
| Facing | ∞ | | | | |
| away | | | | | |
| Light | | | | | |
| Source | | | | | |
| | | 0-0.1 | | | |
| Facing | ∞ | 0.1 | 1.535/56 | ∞ | The Fourth |
| Light | | | | | Optical |
| Source | | | | | Element |
| Facing | ∞ | | | | |
| away | | | | | |
| Light | | | | | |
| Source | | | | | |
| | | 0-0.2 | | | |
| Facing | ∞ | 3-5 | 1.516/64 | ∞ | The Second |
| Light | | | | | Optical |
| Source | | | | | Element |
| Facing | ∞ | | | | |
| away | | | | | |
| Light | | | | | |
| Source | | | | | |
| | | 0.1-0.5 | | | |
| | ∞ | | | | Image Source |

Table 8 shows the parameters and condition values in accordance with the fourth embodiment of the optical apparatus of the present invention.

TABLE 8

| VOU | 0.009-1.162 | mm³ | VLU | 0.003-0.006 | mm³ | V1OE | 1.8-5 | mm³ |
|---|---|---|---|---|---|---|---|---|
| VLS | 0.9-2.5 | mm³ | AOU | 0.3-0.8 | mm² | ALU | 0.03-0.06 | mm² |
| TLS | 0.1 | mm | T1OE | 0.2 | | DLS1OE | 0.5-1 | mm |
| VIM | 9.9-42.5 | mm³ | A2OES1 | 9-25 | mm² | DLS2OES1 | 1-1.8 | mm |
| VOA | 1228.5-8645 | mm³ | DLU2OES2 | 4-6.8 | mm | DISPL1 | 26 | mm |
| TIM | 1.1-1.7 | mm | | | | | | |

| | | | | | |
|---|---|---|---|---|---|
| VOU/VLU | 3-19.37 | V1OE/VLS | 2 | VIM/VOA | 0.5%-0.8% |
| AOU/ALU | 10-13.4 | (TLS + T1OE)/ | 0.3-0.6 | V1OE/VIM | 12%-18% |
| | | DLS1OE | | | |
| A2OES1/ | 9-13.9 | (DLU2OES2 + | 19.2-27.3 | | |
| DLS2OES1 | | DISPL1)/TIM | | | |

The embodiments of the present invention are not limited to the above, for example, the illumination module combined with optical element of the first and second embodiments of the above optical apparatuses can be replaced with the illumination module combined with optical element 100B˜100F as shown in FIG. 1. The size of the polarization beam splitter can be correspondingly adjusted so that the side length is 2-18 mm when the effective focal length of any relay lens in the above embodiment is 5-20 mm. The radius of curvature R on both sides of any of the above micro lens array can be the same or different, and for an embodiment with two micro lens arrays, the radius of curvature R of each other can also be the same or different. It is helpful to adjust the spot size when the radius of curvature R on both sides of the same micro lens array are different or the radius of curvature R of two micro lens arrays are different from each other. Conversely, it is helpful for the uniformity of light when the radius of curvature R are the same. In addition, the structure of the micro lens array, that is, the shape of the side of the optical unit facing the light source and the other side facing away from the light source may not be limited to an arc, but may also be sphere, cone or quadrangular pyramid. The cone can be, for example but not limited to, a cone with a base angle of 15 degrees. In addition, a plane of 0.01 mm to 0.03 mm can be designed between the optical units of the third optical element of the third embodiment is beneficial for the uniformity of light beam. In addition, in other embodiments, the illumination module and the optical apparatus can be further optimized by satisfying at least one of the following conditions:

5≤L≤20, contributes to thinning;

1≤L/d≤2.6, helps to shorten the total optical path length;

γ=f1×fb/fa or L/d, helps to adjust and optimize spot size;

1<fb/fa≤1.3, helps to converge the light beam and achieve the effect of collimation and uniformity of the light beam;
wherein L is the distance traveled by the light beam from the optical element closest to the second optical element to the second optical element and then to the image source. Taking Table 1 as an example, the optical element closest to the second optical element is the first optical element 220a, and taking Table 2 as an example, the optical element closest to the second optical element is the fourth optical element 330b; d is a distance between a lens and the micro lens array closest to the lens when the third optical element is the lens; γ is the magnification; f1 is the effective focal length of the first relay lens; fb is an effective focal length of the second micro lens array; and fa is an effective focal length of the first micro lens array.

In the above table and conditions, a thickness of the microarray lens along the optical axis, that is, for example, the interval from the first surface to the second surface of the first optical element, it is defined as the interval from an apex of the first surface to an apex of the second surface.

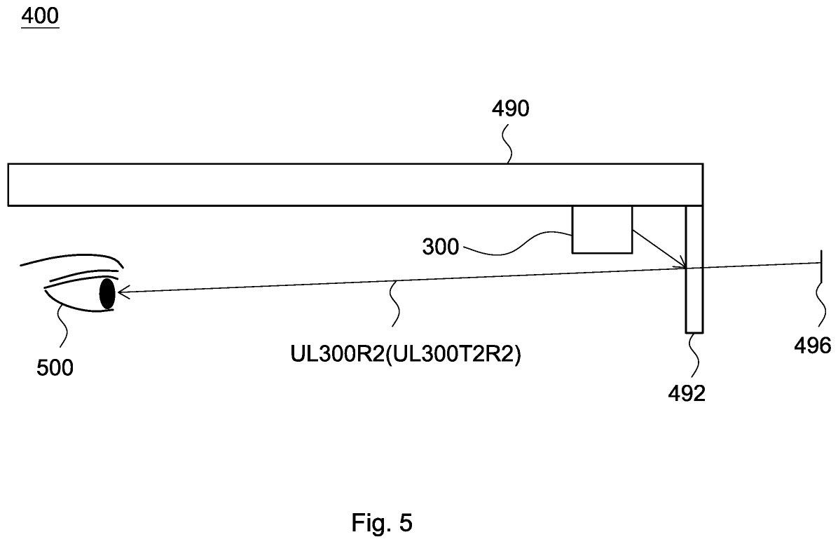

Referring to FIG. 5, FIG. 5 is a schematic diagram of a fifth embodiment of the optical apparatus in accordance with the present invention. The optical apparatus 400 includes an optical apparatus 300 (as shown in FIG. 4), a head-mounted frame 490, and a partially transmitted partially reflective lens 492. The optical apparatus 300 and the partially transmitted partially reflective lens 492 are fixed on the head-mounted frame 490. The user can wear the head-mounted frame 490 on the head, and the projection lens assembly 371 (as shown in FIG. 4) and the projection lens assembly 372 (as shown in FIG. 4) of the optical apparatus 300 (as shown in FIG. 4) project the second reflected light beam UL300R2 and the fourth reflected light beam UL300T2R2, respectively. The second reflected light beam UL300R2 and the fourth reflected light beam UL300T2R2 incident on the partially transmitted partially reflective lens 492, part of the second reflected light beam UL300R2 and part of the fourth reflected light beam UL300T2R2 will directly transmit the partially transmitted partially reflective lens 492, and part of the second reflected light beam UL300R2 and the fourth reflected light beam UL300T2R2 are reflected by the partially transmitted partially reflective lens 492 to the human eyes 500, so that the user can see the virtual image 496 of the image source 361 and the image source 362, and the real world image (from the partially transmitted partially reflective lens 492). The partially transmitted partially reflective lens 492 of FIG. 5 can also be replaced with a total reflection element, and the user can still see the image of the image source 361 and the image source 362 projected on the total reflection element through the eyes, but cannot see the real world image (on the right side of the total reflection element, that is, on the right side of the partially transmitted partially reflective lens 492 of FIG. 5).

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An illumination module comprising:
a light source; and
a first optical element;
wherein the illumination module is set in an optical apparatus;
wherein the light source comprises a plurality of lighting units and each lighting unit emits a light beam, wherein the light beam comprises a colored light and the light source emits a plurality of light beams;
wherein the first optical element comprises a plurality of optical units;
wherein the illumination module satisfies at least one of following conditions:
2≤VOU/VLU≤550;
0.3≤V1OE/VLS≤2.2;
8≤AOU/ALU≤16;
0.6≤(TLS+T1OE)/DLS1OE≤8.9;
0.2%≤V1OE/VIM≤50%;
AOU>ALU×2;
wherein VOU is a volume of the optical unit of the first optical element, VLU is a volume of the lighting unit, V1OE is a volume of the first optical element, VLS is a volume of the light source, AOU is an area of the optical unit of the first optical element, ALU is an area of the lighting unit, TLS is a thickness of the light source, T1OE is a thickness of the first optical element, DLS1OE is a shortest interval from the light source to the first optical element, and VIM is a volume of the illumination module.

2. The illumination module as claimed in claim 1, wherein:
each optical unit comprises a curved surface facing the light source and the curved surface has only one apex;
each optical unit connects each other so that the light beam can enter the optical units at the same time;
the first optical element is disposed on one side of the light source;
the light beams emitted by at least two lighting units are incident and passes through the same optical unit for light mixing; and
the number of the optical unit of the first optical element is less than the number of the lighting unit.

3. The illumination module as claimed in claim 2, wherein:
the optical apparatus comprises a second optical element, a first projection lens assembly, and an image source;
the light beams passes through the illumination module, and then enters the optical apparatus through the second optical element;
the second optical element comprises a reflective surface and the reflective surface can partially reflect and partially transmit, or fully reflect the incident light beams; and
the optical apparatus satisfies at least one of following conditions:
1.25 mm≤A2OES1/DLS2OES1≤50 mm;
2 mm≤DLS2OES1≤20 mm;
0.5%≤VIM/VOA≤19%;
2≤(DLU2OES2+DISPL1)/TIM≤17;
wherein A2OES1 is an area of a first surface of the second optical element, DLS2OES1 is an interval from the light source to the first surface of the second optical element, VIM is a volume of the illumination module, VOA is a volume of the optical apparatus, DLU2OES2 is an interval from the light source to a second surface of the second optical element, DISPL1 is an interval from an image source to a light exiting surface of the first projection lens assembly, and TIM is a minimum interval from a first side surface of the light source to a second side surface of an optical element wherein the optical element is closest to the second optical element.

4. The illumination module as claimed in claim 3, further comprising a third optical element and a fourth optical element, wherein:
the third optical element comprises a lens,
the first optical element is disposed between the light source and the third optical element when the third optical element is the lens; and
the third optical element and the fourth optical element are disposed between the first optical element and the second optical element, and the light beams pass through the first optical element, the third optical element, and the fourth optical element in order, and then enter the second optical element.

5. The illumination module as claimed in claim 4, further comprising a fifth optical element, wherein:
the fifth optical element are disposed between the fourth optical element and the second optical element, and the light beams pass through the first optical element, the third optical element, the fourth optical element, and the fifth optical element in order, and then enter the second optical element.

6. The illumination module as claimed in claim 3, wherein:
the optical apparatus further comprises a sixth optical element, a seventh optical element, a second projection lens assembly, and another image source;
the second optical element is disposed between the image source and the first projection lens assembly;
the light beams incident on the second optical element are partially reflected by the reflective surface and enters the image source, then reflected by the image source to become an image light beam, then the image light beam passes through the second optical element, and then enters the first projection lens assembly;
the first projection lens assembly projects the image light beam to a screen to form an image;
the sixth optical element is disposed between the second optical element and the seventh optical element;
the seventh optical element is disposed between the another image source and the second projection lens assembly, and the seventh optical element comprises a reflective surface;
the light beams incident on the second optical element partially transmits the reflective surface of the second optical element, then enters and passes through the sixth optical element, then enters the seventh optical element, then the transmitted light beams will be reflected by the reflective surface of the seventh optical element and enters to the another image source, then reflected by the another image source to become another image light beam, then enters and passes through the seventh optical element, and then enters the second projection lens assembly;
the second projection lens assembly projects the another image light beam to the screen to form another image;
the light source is a LED array light source and the LED array light source comprises the lighting units of three colors, wherein the plurality of lighting units are arranged in a grid;
the first optical element, the third optical element, and the sixth optical element all are made of plastic material; and
an interval between the second optical element and the seventh optical element along the incident direction of the light beams can be adjusted, so that an interval between two images projected by the first projection lens assembly and the second projection lens assembly can be changed.

7. The illumination module as claimed in claim 2, further comprising a third optical element, wherein:
the third optical element comprises a plurality of optical units;
the first optical element is disposed between the light source and the third optical element, or the third optical element is disposed between the first optical element and the light source when the third optical element comprises the plurality of optical units; and
any optical unit of the first optical element and the third optical element comprises two surfaces with lens structure, wherein one surface with lens structure faces the light source and the other surface with lens structure faces away from the light source, the surfaces with lens structure each has a radius of curvature, and the radiuses of curvature may be the same or different.

8. The illumination module as claimed in claim 1, further comprising a third optical element, wherein:
the third optical element comprises a plurality of optical unit;
the first optical element is disposed between the light source and the third optical element, or the third optical element is disposed between the first optical element and the light source when the third optical element comprises the plurality of optical units; and
each optical unit of the first optical element connects each other so that the light beam can enter the optical units of the first optical element at the same time.

9. The illumination module as claimed in claim 1, wherein:
the optical apparatus comprises a second optical element, a first projection lens assembly, and an image source;
the light beams passes through the illumination module, and then enters the optical apparatus through the second optical element;
the second optical element comprises a reflective surface and the reflective surface can partially reflect and partially transmit, or fully reflect the incident light beams; and
the optical apparatus satisfies at least one of following conditions:
1.25 mm≤A2OES1/DLS2OES1≤50 mm;
2 mm≤DLS2OES1≤20 mm;
0.5%≤VIM/VOA≤19%;
2≤(DLU2OES2+DISPL1)/TIM≤17;
the number of the optical unit of the first optical element is less than the number of the lighting unit;
wherein A2OES1 is an area of a first surface of the second optical element, DLS2OES1 is an interval from the light source to the first surface of the second optical element, VIM is a volume of the illumination module, VOA is a volume of the optical apparatus, DLU2OES2 is an interval from the light source to a second surface of the second optical element, DISPL1 is an interval from an image source to a light exiting surface of the first projection lens assembly, and TIM is a minimum interval from a first side surface of the light source to a second side surface of an optical element wherein the optical element is closest to the second optical element.

10. The illumination module as claimed in claim 1, further comprising a third optical element, wherein:
the third optical element comprises a plurality of optical units; and
any optical unit of the first optical element and the third optical element comprises two surfaces with lens structure, wherein one surface with lens structure faces the light source and the other surface with lens structure faces away from the light source, the surfaces with lens structure each has a radius of curvature, and the radiuses of curvature may be the same or different.

11. The illumination module as claimed in claim 1, further comprising a third optical element and a fourth optical element, wherein:
both of the third optical element and the fourth element comprise a film; and
the third optical element and the fourth optical element are disposed between the first optical element and the second optical element, and the light beams pass through the first optical element, the third optical element, and the fourth optical element in order, and then enter the second optical element.

12. An illumination module comprising:
a light source; and
a first optical element;
wherein the illumination module is set in an optical apparatus;
wherein the light source comprises a plurality of lighting units and each lighting unit emits a light beam, wherein the light beam comprises a colored light and the light source emits a plurality of light beams;
wherein the first optical element comprises a plurality of optical units, each optical unit comprises a curved surface facing the light source and the curved surface has only one apex;
wherein the first optical element is disposed on one side of the light source;
wherein the light beams emitted by at least two lighting units are incident and passes through the same optical unit for light mixing;
wherein each optical unit connects each other so that the light beam can enter the optical units at the same time.

13. The illumination module as claimed in claim 12, wherein the illumination module satisfies at least one of following conditions:
2≤VOU/VLU≤550;
0.3≤V1OE/VLS≤2.2;
8≤AOU/ALU≤16;
0.6≤(TLS+T1OE)/DLS1OE≤8.9;
0.2%≤V1OE/VIM≤50%;
AOU>ALU×2;
the number of the optical unit of the first optical element is less than the number of the lighting unit;
wherein VOU is a volume of the optical unit of the first optical element, VLU is a volume of the lighting unit, V1OE is a volume of the first optical element, VLS is a volume of the light source, AOU is an area of the optical unit of the first optical element, ALU is an area of the lighting unit, TLS is a thickness of the light source, T1OE is a thickness of the first optical element, DLS1OE is a shortest interval from the light source to the first optical element, and VIM is a volume of the illumination module.

14. The illumination module as claimed in claim 13, further comprising a third optical element, wherein:
the optical apparatus further comprises a second optical element;
both of the first optical element and the third optical element are disposed between the light source and the second optical element;
the third optical element comprises a plurality of optical unit; and
any optical unit of the first optical element and the third element comprises two surfaces with lens structure, wherein one surface with lens structure faces the light source and the other surface with lens structure faces away from the light source, the surfaces with lens structure each has a radius of curvature, and the radiuses of curvature may be the same or different.

15. The illumination module as claimed in claim 13, further comprising a third optical element, wherein:
the optical apparatus further comprises a second optical element;
both of the first optical element and the third optical element are disposed between the light source and the second optical element;
the third optical element comprises a plurality of optical units or a lens;
the first optical element is disposed between the light source and the third optical element, or the third optical element is disposed between the first optical element and the light source when the third optical element comprises the plurality of optical units; and
the first optical element is disposed between the light source and the third optical element when the third optical element is the lens.

16. The illumination module as claimed in claim 15, further comprising a fourth optical element, wherein:
the second optical element comprises a reflective surface and the reflective surface can partially reflect and partially transmit, or fully reflect the incident light beams;
the fourth optical element is disposed between the third optical element and the second optical element, and the light beams pass through the first optical element, the third optical element, the fourth optical element in order, and then enter the second optical element

17. The illumination module as claimed in claim 16, wherein:
the optical apparatus further comprises a first projection lens assembly, and an image source, a sixth optical element, a seventh optical element, a second projection lens assembly, and another image source;
the second optical element is disposed between the image source and the first projection lens assembly;
the light beams incident on the second optical element are partially reflected by the reflective surface and enters the image source, then reflected by the image source to become an image light beam, then the image light beam passes through the second optical element, and then enters the first projection lens assembly;
the first projection lens assembly projects the image light beam to a screen to form an image;
the sixth optical element is disposed between the second optical element and the seventh optical element;
the seventh optical element is disposed between the another image source and the second projection lens assembly, and the seventh optical element comprises a reflective surface;
the light beams incident on the second optical element partially transmits the reflective surface of the second optical element, then enters and passes through the sixth optical element, then enters the seventh optical element, then the transmitted light beams will be reflected by the reflective surface of the seventh optical element and enters to the another image source, then reflected by the another image source to become another image light beam, then enters and passes through the seventh optical element, and then enters the second projection lens assembly;
the second projection lens assembly projects the another image light beam to the screen to form another image;
the light source is a LED array light source and the LED array light source comprises the lighting units of three colors, wherein the plurality of lighting units are arranged in a grid;
the first optical element, the third optical element, the fourth optical element, and the sixth optical element all are made of plastic material; and
an interval between the second optical element and the seventh optical element along the incident direction of the light beams can be adjusted, so that an interval between two images projected by the first projection lens assembly and the second projection lens assembly can be changed.

18. The illumination module as claimed in claim 12, wherein:
the optical apparatus further comprises a second optical element, a first projection lens assembly, and an image source;
the light beams passes through the illumination module, and then enters the optical apparatus through the second optical element;
the second optical element comprises a reflective surface and the reflective surface can partially reflect and partially transmit, or fully reflect the incident light beams; and
the optical apparatus satisfies at least one of following conditions:
1.25 mm≤A2OES1/DLS2OES1≤50 mm;
2 mm≤DLS2OES1≤20 mm;
0.5%≤VIM/VOA≤19%;
2≤(DLU2OES2+DISPL1)/TIM≤17;
wherein A2OES1 is an area of a first surface of the second optical element, DLS2OES1 is an interval from the light source to the first surface of the second optical element, VIM is a volume of the illumination module, VOA is a volume of the optical apparatus, DLU2OES2 is an interval from the light source to a second surface of the second optical element, DISPL1 is an interval from an image source to a light exiting surface of the first projection lens assembly, and TIM is a minimum interval from a first side surface of the light source to a second side surface of an optical element wherein the optical element is closest to the second optical element.

19. The illumination module as claimed in claim 18, further comprising a third optical element, wherein:
the third optical element comprises a plurality of optical units;
the first optical element is disposed between the light source and the third optical element, or the third optical element is disposed between the first optical element and the light source when the third optical element comprises the plurality of optical units;
any optical unit of the first optical element and the third optical element comprises two surfaces with lens structure, wherein one surface with lens structure faces the light source and the other surface with lens structure faces away from the light source, the surfaces with lens structure each has a radius of curvature, and the radiuses of curvature may be the same or different.

20. The illumination module as claimed in claim 12, further comprising a third optical element and a fourth optical element, wherein:
the optical apparatus further comprises a second optical element;
both of the third optical element and the fourth element comprise a film; and
the third optical element and the fourth optical element are disposed between the first optical element and the second optical element, and the light beams pass through the first optical element, the third optical element, and the fourth optical element in order, and then enter the second optical element.
